(19) United States
(12) Patent Application Publication
(10) Pub. No.: US 2022/0011052 A1
(43) Pub. Date: Jan. 13, 2022

(54) METHOD FOR MANUFACTURING A HEAT EXCHANGER COMPRISING A ZONE TO BE SUPPORTED AND HEAT EXCHANGER MANUFACTURED USING SUCH A METHOD

(71) Applicant: L'Air Liquide, Societe Anonyme pour l'Etude et l'Exploitation des Precedes Georges Claude, Paris (FR)

(72) Inventors: Camille MARIE, Vitry Sur Seine (FR); Eric MASLIAH, Vitry Sur Seine (FR); Ludovic AMANT, Vitry Sur Seine (FR); Arnaud GUEGUEN, Vitry Sur Seine (FR)

(73) Assignee: L'Air Liquide, Societe Anonyme pour l'Etude et l'Exploitation des Procedes Georges Claude, Paris (FR)

(21) Appl. No.: 17/294,386

(22) PCT Filed: Nov. 20, 2019
(86) PCT No.: PCT/FR2019/052761

§ 371 Date: May 14, 2021

(30) Foreign Application Priority Data
Nov. 26, 2018 (FR) FR1871822

(51) Int. Cl. F28D 9/00; F28F 3/08

(52) U.S. Cl. CPC F28D 9/0062; F28F 2275/04; F28F 3/08; F28D 9/0093

(57) ABSTRACT

The invention relates to a method for manufacturing a brazed plate type heat exchanger comprising the following steps: a) stacking, with a clearance, a plurality of plates parallel to each other so as to define, between said plates, a plurality of passages suitable for the flow of at least one fluid, said passages being delimited by peripheral edges and at least one passage comprising at least one zone to be supported emerging towards the outside of the passage through at least one opening of a peripheral edge; b) arranging at least one support member in the zone to be supported; c) brazing the stack of plates comprising the support member; and d) removing the support member from the zone to be supported through the opening. According to the invention, the support member is deformable and, in step d), a traction force is exerted on the support member so as to cause a deformation in at least one part of the support member and a translation movement of the support member towards the outside of the passage.

### CROSS REFERENCE TO RELATED APPLICATIONS

This application is a § 371 of International PCT Application PCT/FR2019/052761, filed Nov. 20, 2019, which claims the benefit of FR1871822, filed Nov. 26, 2018, both of which are herein incorporated by reference in their entireties.

### FIELD OF THE INVENTION

The present invention relates to a method for manufacturing a heat exchanger of the brazed plate type, having at least one zone that is to be supported, and to a heat exchanger manufactured using such a method.

### BACKGROUND OF THE INVENTION

The present invention notably finds application in the field of the cryogenic separation of gases, in particular the cryogenic separation of air, in what is known as an ASU (air separation unit) used to produce pressurized gaseous oxygen. In particular, the present invention may apply to the manufacture of a heat exchanger that vaporizes a flow of liquid, for example liquid oxygen, nitrogen and/or argon, by exchanging heat with a gaseous flow, for example air or nitrogen.

The present invention may also apply to a heat exchanger that vaporizes at least one flow of liquid-gas mixture, in particular a flow of multi-constituent mixture, for example a mixture of hydrocarbons, through exchange of heat with at least one other fluid, for example natural gas.

The technology that is commonly used for heat exchangers is that of brazed-plate heat exchangers, which make it possible to obtain highly compact components that afford a large heat-exchange surface area. These heat exchangers are made up of parallel plates, between which are inserted heat-exchange structures, particularly corrugations, or waves, thus constituting a stack of flat passages for the various fluids to be put into a heat-exchange relationship.

The heat exchange structures of brazed-plate heat exchangers not only have the function of increasing the heat exchanger surface area for the exchange of heat but also act as spacers between the plates.

Specifically, when the exchanger is being manufactured, a compression device is used to press together the stack of plates, spacer elements and other constituent elements of the exchanger. These elements are then bonded together by brazing in a vacuum furnace at temperatures of between 550 and 650° C., with the application of a compressive force typically ranging from 20 000 to 40 000 N/m².

During the brazing cycle, the separator plates are subjected to high levels of stress. The spacer elements provide the passages of the exchanger with rigidity and affords them the ability to withstand the compression, preventing the plates from deforming by creep.

Now, for certain applications, it is desirable to create, in passages of the exchanger, zones in which fluid can circulate freely, namely free volumes or zones in which there is no obstacle to the circulation of the fluid. Such free volumes are also present in the exchangers in which the intensification of the heat exchanges is obtained, not by spacer elements arranged between the plates, but by specific coatings applied to the plates.

In these configurations, the passages fully or partially exhibit zones of reduced strength at which the plates are liable to deform during the brazing step. This then results in impaired mechanical strength and fluidtightness of the passages of the exchanger after it has been brazed. Document EP-A-2271456 teaches a method for manufacturing a heat exchanger in which a set of spacers is introduced into the passages of the exchanger in order to ensure the rigidity thereof during brazing. This set is made up of several spacers of specific geometry joined together and the removal of which is performed by imposing a rotational movement on each spacer.

Furthermore, document DE-B-1190910 discloses the use of rigid spacers in the passages of an exchanger prior to brazing, the spacers being removed after brazing by pulling on them using dedicated tools.

### SUMMARY OF THE INVENTION

It has been found that the existing solutions are not entirely satisfactory, particularly as a result of the complexity of the holding components used, of the significant number of elements that have to be manipulated and/or of the difficulty in removing them after the brazing operation, this being something that may cause the passages to become damaged. In addition, because of their shape, the surface density of zones for contact with the adjacent plates is insufficient with the known holding components, leading to uneven supporting of the zones that are to be supported.

It is a notable objective of the present invention to solve all or some of the above-mentioned problems by proposing a method for manufacturing a brazed-plate heat exchanger that is able to ensure the mechanical strength of the exchanger during brazing and which is not as complex to implement as the solutions of the prior art.

To this end, the subject of the invention is a method for manufacturing a heat exchanger of the brazed plate type, comprising the following steps:

a) stacking several mutually parallel plates with spacings so as to define between said plates a plurality of passages suitable for the flow of at least one fluid, said passages being delimited by peripheral edges and at least one passage comprising at least one zone that is to be supported, opening toward the outside of the passage via at least one opening of a peripheral edge,

b) arranging at least one supporting member in the zone that is to be supported,

c) brazing the stack of plates comprising the supporting member, and

d) removing the supporting member from the zone that is to be supported, via the opening,

wherein in step d), a pulling force is applied to the supporting member so as to cause at least part of the supporting member to deform, and to cause said supporting member to move in translation towards the outside of the passage.

Depending on the case, the exchanger according to the invention may comprise one or more of the following features:
the supporting member is arranged in the zone that is to be supported during the stacking step a).
the supporting member is plastically deformable.
the supporting member undergoes plastic deformation.
the pulling force is directed overall in a direction parallel to the plates and perpendicular to the peripheral edge comprising the opening.
in step b), a portion of the supporting member extends beyond the opening toward the outside of the passage and forms a portion for grasping of the supporting member.
the passage comprises a pair of peripheral edges extending in a longitudinal direction and another pair of peripheral edges extending in a lateral direction, one or the other pair having two openings arranged facing one another respectively in the longitudinal direction or in the lateral direction, the zone that is to be supported opening toward the outside of said passage via the two openings.
two distinct supporting members are arranged in at least one zone that is to be supported, a pulling force being applied to each of the two supporting members so as to cause each supporting member to deform and to move in translation in two opposite directions toward the outside of the passage via the respective openings.
the supporting member, under the effect of the pulling force, experiences deformation simultaneously in a first direction, which is parallel to the direction of stacking of the plates and in a second direction which is parallel to the plates and perpendicular to said at least one peripheral edge comprising the opening, notably in one or the other of the lateral and longitudinal directions.
the supporting member has, prior to step e), an initial dimension, measured in the second direction, and an initial height, measured in the first direction, the supporting member experiencing, under the effect of the pulling force, an increase in the initial dimension and a decrease in the initial height.
the plates are coated with a braze material having a predetermined melting temperature, the supporting member being formed in full or in part from a first material having a melting temperature higher than said predetermined temperature.
the supporting member comprises an internal part formed from a second material and two external elements formed from the first material, each external element being arranged between the internal part and an adjacent plate, the second material having a melting temperature lower than the melting temperature of the first material.
the supporting member comprises several fins or corrugation legs extending in the passage in such a way as to delimit a plurality of channels for the flow of a first fluid.
the fins or corrugation legs succeed one another in a first direction parallel to the plates and perpendicular to the peripheral edge comprising the opening.
the supporting member comprises a corrugated product comprising a succession of corrugation legs alternately connected by corrugation crests and corrugation troughs.
the supporting member has a density, defined as being the number of corrugation legs or fins per unit length measured in the lateral first direction, of at least 6 legs per 2.54 centimeters, and/or of at most 26 legs per 2.54 centimeters.

The invention also relates to a heat exchanger manufactured using a method according to the invention, said exchanger comprising several mutually parallel stacked plates with spacings so as to define between them a plurality of passages suitable for the flow of at least one fluid, at least one passage comprising closure bars arranged between two consecutive plates so as to delimit peripheral edges of the passage, wherein the volume of the passage delimited between the closure bars is free of any spacer element.

As a preference, the brazed-plate heat exchanger comprises a stack of passages delimited by peripheral edges, at least one passage 3 comprising at least one zone that is to be supported, extending between two opposing peripheral edges, said zone that is to be supported being free of any spacer element.

The passage may extend over a first length L1 in the longitudinal direction z and over a first width D1 in the lateral direction x, the zone that is to be supported having a second length L2 and/or having a second width D2, measured respectively in the longitudinal direction z and the lateral direction x, of at least 1%, preferably at least 5%, more preferably still, at least 10%, of the first length L1 or of the first width D1 of the passage.

### BRIEF DESCRIPTION OF THE DRAWINGS

Further features, advantages and possible applications of the invention are apparent from the following description of working and numerical examples and from the drawings.

The invention will now be understood better by virtue of the following description, which is given by way of non-limiting example and with reference to the appended figures, in which:

FIG. 1 is a three-dimensional view of a brazed-plate heat exchanger that can be manufactured using a method according to the invention.

FIG. 2 is a partial view of the exchanger of FIG. 1,

FIG. 3 is a view in longitudinal section of a passage of the exchanger of FIG. 1,

FIG. 4 is a view in cross section of a stack of passages comprising a supporting member according to one embodiment of the invention,

FIG. 5 is a view in cross section of a stack of passages comprising a supporting member according to another embodiment of the invention,

FIG. 6 is a view in cross section of a supporting member according to one embodiment of the invention.

### DETAILED DESCRIPTION OF THE INVENTION

All described and/or depicted features on their own or in any desired combination form the subject matter of the invention, irrespective of the way in which they are combined in the claims or the way in which said claims refer back to one another.

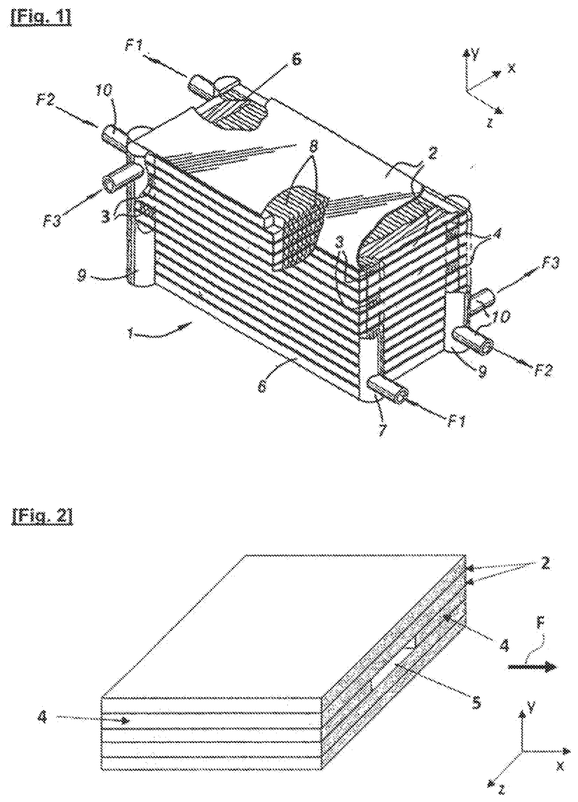

FIG. 1 shows a heat exchanger 1 of the brazed plate type that comprises a stack of plates 2 that extend in two dimensions, length and width, in the longitudinal direction z and the lateral direction x, respectively. The plates 2 are arranged parallel to each other and one above another with a spacing, and thus form several sets of passages 3 for a fluid F1, and at least one other fluid F2, F3 to be placed in an indirect heat-exchange relationship via the plates 2. The lateral direction x is orthogonal to the longitudinal direction z and parallel to the plates 2.

Preferably, each passage has a flat and parallelepipedal shape. The passages extend lengthwise in the longitudinal direction z and widthwise in the lateral direction x. The spacing between two successive plates 2, corresponding to the height of the passage, measured in the stacking direction y of the plates 2, is small compared with the length and the width of each successive plate.

The passages 3 are bordered by closure bars 6 which do not completely obstruct the passages but leave free openings for the inlet or the outlet of the corresponding fluids.

The exchanger 1 comprises semi-tubular manifolds 7, 9 provided with openings 10 for introducing fluids into the exchanger 1 and for discharging fluids out of the exchanger 1. These manifolds have openings that are narrower than the passages. Distribution zones arranged downstream of the inlet manifolds and upstream of the outlet manifolds are used to homogeneously channel the fluids to or from the entire width of the passages.

As a preference, the exchanger 1 is of the brazed plate and fin type. At least some of the passages 3 comprise fin spacer elements 8 that extend advantageously across the width and along the length of the passages of the heat exchanger, parallel to the plates 2. In the illustrated example, the spacer elements 8 comprise heat-exchange corrugations in the form of corrugated sheets. In this case, the corrugation legs that connect the successive tops and bottoms of the corrugation are referred to as “fins”. The spacer elements 8 can also adopt other particular shapes that are defined according to the desired fluid flow characteristics. More generally, the term “fins” covers blades or other secondary heat-exchange surfaces, which extend from the primary heat-exchange surfaces, that is to say the plates of the heat exchanger, into the passages of the heat exchanger.

Note that in the context of the invention, the term “spacer element” does not cover any closure bars 6 that might be put in place to at least partially close off the peripheral edges 4 of the passage 3. A “spacer element” preferably means a finned heat-exchange structure, for example a heat-exchange corrugation, arranged between two plates 2.

In the context of the invention, at least one passage 3 of the exchanger comprises at least one zone 12 that is to be supported (and that is not visible in FIG. 1). This zone 12 that is to be supported is preferably a zone that is free of any spacer element, namely a volume that is left free between two adjacent plates 2.

The zone 12 that is to be supported may also be a zone that is provided with spacer elements but in which the fin density is lower than in another zone of the one and the same passage 3, or in which the fin density is lower than in another zone of another adjacent passage 3.

It being specified that the passage 3 may comprise a single zone 12 that is to be supported or else a plurality of zones 12 that are to be supported, these being positioned at intervals along the lateral direction x or along the longitudinal direction z, for example zones 12 that are to be supported, separated by one or more retaining bars extending in the height of the passage 3.

FIG. 2 depicts passages 3 delimited by peripheral edges 4 which are preferably mutually parallel in pairs in the lateral direction x and the longitudinal direction z. The edges situated facing one another are said to be opposing faces. The zone 12 that is to be supported opens to the outside of the passage 3 via at least one opening 5 formed at a peripheral edge 4.

According to the invention, before the exchanger is brazed, at least one supporting member 11 is arranged in the zone 12 that is to be supported. After brazing, the supporting member 11 is removed via the opening 5 by applying at least one pulling force (arrow F) to it. This force is applied in such a way as to cause the supporting member 11 to deform and to move in translation toward the outside of the passage 3.

The supporting member 11 thus provides the zone 12 that is to be supported with mechanical rigidity during the assembly of the exchanger by brazing, and the removal of the supporting member 11 can be performed simply and quickly without the need to impose a complex movement on it. Using a supporting member 11 that is deformable makes it easier to remove and reduces the risk of damaging or deforming the passage 3 in which it was inserted.

Note that the supporting member 11 may be arranged in the zone 12 that is to be supported during or after the step of stacking the plates 2.

According to one advantageous embodiment, the supporting member 11 is arranged in the zone 12 that is to be supported during the step of stacking the plates 2. In particular, when considering two plates that are to be stacked one on top of the other in order to define a passage 3 between them, the supporting member 11 is positioned before one of the two plates is stacked on the other. This then avoids operating on the matrix created by the stacking, and limits the risk of damaging the stack or of displacing one element of the stack when inserting the supporting member 11 in the passage 3, which would compromise the operation of the exchanger.

It is emphasized that said at least one force F can be applied continuously or in a number of instalments, to the supporting member 11, with an intensity that may be variable or constant.

As a preference, the supporting member is at least partially plastically deformable. The supporting member is configured to fully or partly undergo plastic deformation, i.e. irreversible deformation. This further facilitates the removal of the supporting member, since it is not necessary for the force F to be applied continuously.

As a preference, the translational movement of the member 11 begins after or during the deformation of the supporting member 11. This then further reduces the risk of damaging or deforming the passage 3.

The pulling force is advantageously directed in a direction substantially parallel to the plates 2 and perpendicular to the direction of extension of the peripheral edge 4 at which the opening 5 is arranged. In the configuration of FIG. 2, the opening 5 is situated on a longitudinal edge parallel to the longitudinal direction z, and the force F is directed in the lateral direction x. As a preference, under the effect of the force F, the supporting member 11 experiences deformation simultaneously in the direction in which the force is applied, namely the lateral direction x in the example of FIG. 2 and in the direction of stacking y which is orthogonal to the plates 2.

Advantageously, the supporting member 11 experiences an increase in its initial dimension Di, Di being measured in a second direction which is parallel to the plates 2 and perpendicular to the peripheral edge 4 comprising the opening 5, particularly in one or the other of the lateral x or longitudinal z directions, depending on the positioning of the opening 5 and on the direction of the pulling force, and a reduction in its initial height hi, hi being measured in a first direction which is parallel to the direction of stacking y.

As a preference, the pre-deformation height of the supporting member 11 is such that the member 11 extends into practically all, or even all, of the height of the passage 3 in the direction of stacking y, so that no or practically no play exists between the member 11 and the adjacent plates 2. This allows effective support to be provided during the brazing of the exchanger. The reduction in the height of the member 11 under the effect of the pulling force allows the translational movement of the member 11 toward the outside of the passage 3.

Advantageously, the supporting member 11 is arranged in the zone 12 that is to be supported in such a way that a portion of the member extends beyond the opening 5 toward the outside of the passage 3. Thus, the portion of the member that extends beyond the closure bar 6 of the edge 4 concerned forms a portion for manual or mechanical grasping, thereby facilitating the removal of the supporting member 11.

FIG. 2 depicts an embodiment in which an opening 5 is arranged on a peripheral edge 4 parallel to the longitudinal direction z.

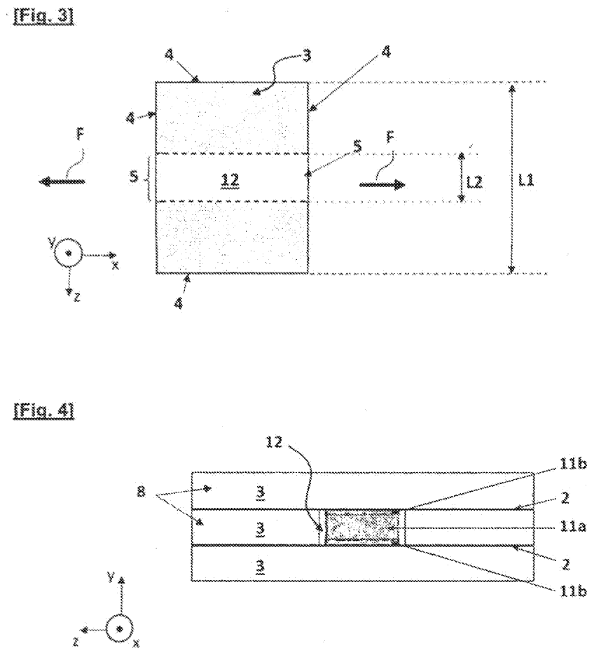

FIG. 3 depicts an embodiment in which the zone 12 that is to be supported passes all the way through and opens to the outside of the passage 3 via two openings 5 arranged on opposing peripheral edges 4. The opposing openings 5 may be arranged on a pair of longitudinal peripheral edges, as illustrated in FIG. 3, or on a pair of lateral peripheral edges which extend in the lateral direction x.

It is then advantageous to arrange in the zone 12 that is to be supported, two supporting members 11, each of which being removed via one of the openings 5 under the effect of opposing pulling forces F.

It will be noted that, in the context of the invention, several passages 3 of the exchanger 1 may have at least one zone 12 that is to be supported, it being possible for these passages to have different configurations, particularly different numbers of openings and openings arranged on different edges.

In order to allow the elements of the exchanger to be assembled using brazing, the plates 2 are preferably coated with a braze or braze material having a predetermined melting temperature.

Advantageously, the supporting member 11 is fully or partly formed from a first material with a melting temperature that is higher than said predetermined temperature. Thus, the supporting member is not brazed with the plates 2 of the passage 3 and can be removed easily.

FIG. 4 illustrates an embodiment in which the supporting member 11 comprises an internal part 11a formed from a second material and two external elements 11b formed from the first material, each external element 11b being arranged between the internal part 11a and an adjacent plate 2, the second material having a melting temperature lower than the melting temperature of the first material.

The internal part 11a constitutes the deformable part of the supporting element 11, and the two external elements 11b act as insulators preventing the part 11a from being brazed to the adjacent plates 2.

Thus, a greater degree of freedom is available with respect to the selection of the material of the internal part 11a, which can potentially have a melting temperature that is less than or equal to the predetermined melting temperature. For example, the external elements 11b can be formed by an iron alloy, in particular stainless steel. The internal part can be formed by aluminum or by an aluminum alloy.

Advantageously, the external elements 11b take the form of planar components, for example sheets or strips. That makes it possible to have a near-continuous, or even continuous, zone of contact with the adjacent plates 2, thus further improving the mechanical strength of the zone 12 that is to be supported.

In this embodiment, the method according to the invention is preferably performed in two sub steps: the removal of the internal part 11a by means of the pulling force with deformation and translational movement of the internal part 11a toward the outside of the passage 3, and removal of the two external elements 11b without deformation of said elements 11b.

FIG. 5 depicts an alternative embodiment in which the supporting member 11 is a component made solely from the first material. For example, use may be made of an iron alloy, such as stainless steel, by way of first material that cannot be brazed to the plates 2.

As a preference, the supporting member 11 or the internal part 11a thereof, takes the form of a spacer element of the finned type. The member 11 thus comprises several fins or corrugation legs which extend in the passage 3 in such a way as to form secondary heat-exchange surfaces and to delimit a plurality of channels 13 for the flow of a fluid. The method according to the invention is thus easily implemented on an industrial scale, with an investment cost that is low because conventional sheets of corrugations can be used as supporting members. Furthermore, this type of element offers a surface density of zones of contact with the adjacent plates that is greater than is offered by supporting components of the prior art.

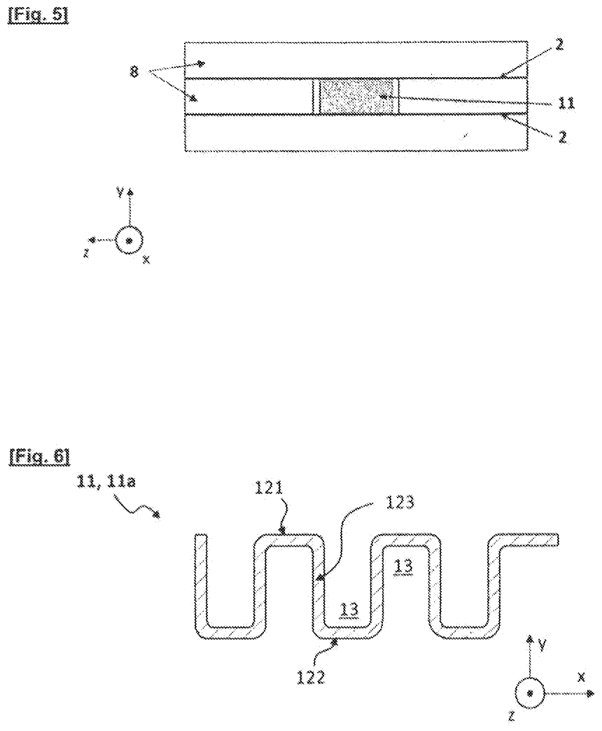

FIG. 6 depicts an advantageous embodiment in which the supporting member 11 comprises a corrugated product 11, 11a comprising a succession of corrugation legs 123 alternately connected by corrugation crests 121 and corrugation troughs 122. As a preference, the corrugated product is arranged in the zone 12 that is to be supported in such a way that the corrugation legs 123 succeed one another in a direction parallel to the plates 2 and perpendicular to the peripheral edge 4 comprising the opening 5, when considered in the plane (y,z) in FIG. 4. The supporting member 11 thus deforms readily by unfolding in the direction parallel to the plate 2 and perpendicular to the peripheral edge 4. The unfolding is notably manifested by an elongation of the member 11 and a reduction in the height of the member 11 under the effect of the pulling force, thereby allowing the member 11 its translational movement toward the outside of the passage 3.

FIG. 6 is a view in cross section of a supporting member 11, 11a in the form of a rectangular corrugation, the corrugation legs 123 of which have flat surfaces. The supporting member 11 may also be a corrugated product selected from partially-offset, wavy or herringbone corrugations, which may or may not be perforated.

As a preference, the supporting member 11 has a predetermined density, defined as being the number of corrugation legs or fins per unit length, measured in the direction of corrugation, for example the lateral direction x in the configuration of FIG. 2 to FIG. 6. As a preference, said density is at least 6 legs per 2.54 centimeters, and preferably at most 26 legs per 2.54 centimeters. Such values allow the passage 3 to be stiffened effectively during brazing while at the same time facilitating removal of the supporting member.

Advantageously, when considering a passage 3 provided with the spacer elements conventionally encountered in braised-plate heat exchangers, the supporting member 11 has a number of legs per 2.54 centimeters that is the same or almost the same as the number of legs per 2.54 centimeters of the spacer elements arranged in the same passage 3 as the zone 12 that is to be supported or in the passages adjacent to the passage 3 comprising the zone that is to be supported.

For a passage 3 extending over a first length L1 measured in the longitudinal direction z, the zone 12 that is to be supported has a second length L2, measured in the longitudinal direction z, that corresponds to at least 1%, preferably at least 5%, more preferably still, at least 10%, of the first length L1.

The method according to the invention is particularly advantageous when the exchanger that is to be manufactured has at least one zone 12 that is to be supported, the extent of which is relatively great in comparison with the dimensions of the passages 3 of the exchanger.

Thus, the length of the zone 12 that is to be supported may represent more than half of the length of the passage 3, preferably more than 80%, and may even extend over almost all of the length of the passage 3, typically may have a length L2 representing 98% or more of the first length L1, or even over the entirety, L2 then representing 100% of L1. The passage 3 is then empty, or almost empty, which is to say free of spacer elements.

It is emphasized that, in the context of the invention, the length of the passage 3 is measured between two opposing peripheral edges 4 and corresponds to the distance between two opposing closure bars 6 when the passage 3 is closed by such bars.

The dimensional relationships and features mentioned here may of course apply to the width of the passage 3 and of the zone 12 that is to be supported, measured in the lateral direction x, in instances in which the zone 12 that is to be supported opens to the outside of the passage 3 via at least one opening 5 arranged on a peripheral edge 4 extending parallel to the lateral direction x.

Of course, the invention is not limited to the particular examples described and illustrated in the present application. Further variants or embodiments within the competence of a person skilled in the art may also be envisaged without departing from the scope of the invention defined in the following claims.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-16. (canceled)

17. A method for manufacturing a heat exchanger of the brazed plate type, comprising the following steps:
a. stacking several mutually parallel plates with spacings so as to define between said plates a plurality of passages suitable for the flow of at least one fluid, said passages being delimited by peripheral edges and at least one passage comprising at least one zone that is to be supported, opening toward the outside of the passage via at least one opening of a peripheral edge,
b. arranging at least one supporting member in the zone that is to be supported,
c. brazing the stack of plates comprising the supporting member, and
d. removing the supporting member from the zone that is to be supported, via the opening,
wherein the supporting member is deformable and, in step d), a pulling force is applied to the supporting member so as to cause at least part of the supporting member to deform, and to cause said supporting member to move in translation towards the outside of the passage.

18. The method as claimed in claim 17, wherein the supporting member is arranged in the zone that is to be supported during the stacking step a).

19. The method as claimed in claim 17, wherein the supporting member undergoes plastic deformation.

20. The method as claimed in one of the preceding claims, characterized in that the pulling force is directed overall in a direction parallel to the plates and perpendicular to the peripheral edge comprising the opening.

21. The method as claimed in claim 17, wherein, in step b), a portion of the supporting member extends beyond the opening toward the outside of the passage and forms a portion for grasping of the supporting member.

22. The method as claimed in claim 17, wherein the passage comprises a pair of peripheral edges extending in a longitudinal direction (z) and another pair of peripheral edges extending in a lateral direction (x), one or the other pair having two openings arranged facing one another respectively in the longitudinal direction (z) or in the lateral direction (x), the zone that is to be supported opening toward the outside of said passage via the two openings.

23. The method as claimed in claim 22, wherein two distinct supporting members are arranged in the zone that is to be supported, a pulling force being applied to each of the two supporting members so as to cause each supporting member to deform and to move in translation in two opposite directions toward the outside of the passage via the respective openings.

24. The method as claimed in claim 17, wherein the supporting member, under the effect of the pulling force, experiences deformation simultaneously in at least a first direction, which is parallel to the direction of stacking (y) of the plates and in a second direction which is parallel to the plates and perpendicular to the peripheral edge comprising the opening.

25. The method as claimed in claim 24, wherein the supporting member has, prior to step e), an initial dimension (Di), measured in the second direction, and an initial height (hi), measured in the first direction, the supporting member experiencing, under the effect of the pulling force, an increase in the initial dimension (Di) and a decrease in the initial height (hi).

26. The method as claimed in claim 17, wherein the plates are coated with a braze material having a predetermined melting temperature, the supporting member being formed in full or in part from a first material having a melting temperature higher than said predetermined temperature.

27. The method as claimed in claim 17, wherein 26the supporting member comprises an internal part formed from a second material and two external elements formed from the first material, each external element being arranged between the internal part and an adjacent plate, the second material having a melting temperature lower than the melting temperature of the first material.

28. The method as claimed in claim 17, wherein the supporting member comprises several fins or corrugation legs extending in the passage in such a way as to delimit a plurality of channels for the flow of a first fluid.

29. The method as claimed in claim 28, wherein the fins or corrugation legs succeed one another in a first direction parallel to the plates and perpendicular to the peripheral edge comprising the opening.

30. The method as claimed in claim 17, wherein the supporting member comprises a corrugated product comprising a succession of corrugation legs alternately connected by corrugation crests and corrugation troughs.

31. The method as claimed in claim 30, wherein the fins or corrugation legs succeed one another in a first direction parallel to the plates and perpendicular to the peripheral edge comprising the opening.

32. The method as claimed in claim 28, wherein the supporting member has a density, defined as being the number of corrugation legs or fins per unit length measured in the lateral first direction, of at least 6 legs per 2.54 centimeters, and/or of at most 26 legs per 2.54 centimeters.

33. A brazed-plate heat exchanger comprising several mutually parallel stacked plates with spacings so as to define between them a plurality of passages suitable for the flow of at least one fluid, said passages being delimited by peripheral edges, wherein at least one passage comprises at least one zone that is to be supported, extending between two opposing peripheral edges, said zone that is to be supported being free of any spacer element, the passage extending over a first length in the longitudinal direction (z) and over a first width (D1) in the lateral direction (x) and the zone that is to be supported having a second length and/or having a second width, measured respectively in the longitudinal direction (z) and the lateral direction (x), of at least 1%, of the first length (L1) or of the first width (D1) of the passage.
